(19) United States
(12) Patent Application Publication
(10) Pub. No.: US 2010/0310733 A1
(43) Pub. Date: Dec. 9, 2010

(54) PRESSURIZED COOKING OVEN

(76) Inventor: Steve Hoffman, Mahwah, NJ (US)

Correspondence Address: DRINKER BIDDLE & REATH;ATTN: INTELLECTUAL PROPERTY GROUP, ONE LOGAN SQUARE, SUITE 2000, PHILADELPHIA, PA, 19103-6996, US

(21) Appl. No.: 12/734,737

(22) PCT Filed: Nov. 25, 2008
(86) PCT No.: PCT/US08/13096

§ 371 Date: May 20, 2010

Related U.S. Application Data
(60) Provisional application No. 61/004,605, filed on Nov. 28, 2007.

(51) Int. Cl. A47J 27/08; A47J 27/04; A21B 1/22; A23L 1/01

(52) U.S. Cl. 426/233; 99/473; 219/401; 426/523; 426/509

(57) ABSTRACT

A pressurized cooking oven system is disclosed that includes an oven enclosure having front, back, top, bottom and side walls. A door is hingedly attached to one of the walls for sealing an opening in the walls. A heating system is connected to the enclosure for generating heat in the enclosure. The heating system may be a gas or electric heating system. A process is also disclosed for cooking a food item in an oven. The process involves generating heat within the oven; creating pressure within the oven enclosure above atmospheric pressure during at least a portion of the cooking process; maintaining the pressure within the oven enclosure during at least a portion of the heating process; and controlling the heating and pressure during the cooking process.

### FIELD OF THE INVENTION

The present invention generally relates to cooking ovens and, more particularly, to an improved cooking oven designed to operate at elevated pressures and temperatures.

### BACKGROUND

The process of cooking of food generally involves raising the internal temperature of the food to a specified level. The higher the internal temperature is raised, the more “cooked” the food is. For example, raw meat at room (ambient) temperature starts off at approximately 70 degrees F. As the meat is heated the temperature of the meat rises. While temperatures vary depending on the type of meat, the consistency and the thickness, generally speaking, for rare meat, the internal temperature (temperature near the center) is approximately 120 to 130 degrees F. Meat in its medium state has an internal temperature of about 140 to 150 degrees F. Meat is deemed well done when the internal temperature is about 160° F. or more degrees F.

There are a variety of conventional methods for cooking foods, such as on top of a flame (grilling, pan frying) and in an oven (e.g., baking, broiling). In all methods, the same concept of raising the temperature of the product is the ultimate goal. How that is accomplished affects the taste and time involved in the cooking process.

There are three primary forms of heat transfer that occur in a cooking process. Conduction is direct heat flow through matter, such as the conduction of heat from the hot surface of a stove to a cooking pot, or from the surface of the food into the center of the food. More particularly, conduction is heat transfer by means of molecular agitation within a material (i.e., the vibration of the material's atoms) without any motion of the material as a whole. As such, the higher vibrating atoms transfer their increased energy to less energetic neighboring atoms. The result is no net motion of the solid as the energy propagates through the material. For example, if one end of a metal rod is heated to a higher temperature than the other end, energy will be transferred down the rod toward the colder end because the higher speed particles will collide with the slower ones with a net transfer of energy to the slower ones. For heat transfer between two surfaces, the rate of conduction heat transfer is:

$$\frac{Q}{t} = \frac{κ A ( {T}_{hot} - {T}_{cold} )}{d} \qquad Equation 1$$

### Where:

Q=heat transferred in time

κ=thermal conductivity of the barrier

A=area

T=temperature

d=thickness of barrier.

Gases transfer heat by direct collisions between molecules and, as would be expected, the thermal conductivity of a gas is low compared to most solids.

Convection is heat transfer by the motion of a heated fluid such as air or water when the heated fluid is caused to move away from the source of heat, carrying energy with it. The heat travels upward with the natural upward movement of air. Convection above a hot surface occurs because the surface heats the air adjacent to it. As the air heats up, it expands becoming less dense, and rising.

Convection can also lead to circulation of a fluid. For example, as a pot of water is heated over a flame, the heated water expands and becomes more buoyant. Cooler, more dense water near the surface descends and patterns of circulation form. By controlling the circulation of the heated fluid it is possible to maximize heating or cooling of a particular location. In an oven, by controlling the flow of heated air, it is possible to maximize the heating of an item within the oven.

Radiation is the third form of heat transfer and is the transmission of electromagnetic rays through space. These rays have no temperature, only energy. Every material or object with a temperature above absolute zero emits these rays.

In a conventional oven the food is located spaced apart from the heat source. Air separates the food from the heat source. As such the heating process in a conventional oven involves radiation (from the heating source to the food), conduction (from the surface of the food toward the center of the food), and to a lesser degree convection (due to the naturally occurring heat flow in the oven.)

A convection oven operates in a slightly different manner than a conventional oven. In a convection oven, a fan mounted within the oven produces circulation of the heated air within the oven. The fan circulates the air rapidly through the cooking chamber. This circulation of air has two principal effects. First, it causes the temperatures throughout the oven to be almost exactly equal. In a conventional oven, differences in temperature typically occur that can lead to uneven cooking and could require that the food be placed in specific areas within the oven to make sure that the food cooks properly. Convention ovens eliminate this problem. Second, a convection oven transfers heat more evenly to the food. The movement of the hot air past the food prevents regions of colder air from building up near the surfaces of cool foods. As such, the food in a convection oven heats and cooks faster.

Also, since the heated air is forced past the food, a convection oven can operate at a lower temperature than a standard conventional oven and still cook food more quickly. Generally, with a convection oven there will be about a 25% reduction in cooking temperature and a 20% reduction in cooking time, compared to a conventional oven.

There also tends to be less shrinkage with a convection oven, and, because the heat is forced to circulate in the oven, a convection oven can be filled as long as about an inch of space is left for the air to circulate between the food and the oven walls.

In recent years, microwave ovens have become commonplace in the household. A microwave oven uses microwaves to heat food. Microwaves are radio waves. In the case of microwave ovens, the commonly used radio wave frequency is roughly 2,500 megahertz (2.5 gigahertz). Radio waves in this frequency range have an interesting property: they are absorbed by water, fats and sugars. When they are absorbed they are converted directly into atomic motion—heat. Microwaves in this frequency range have another interesting property: they are not absorbed by most plastics, glass or ceramics.

In a conventional oven, the heat migrates (by conduction) from the outside of the food toward the middle. You also have dry, hot air on the outside of the food evaporating moisture on the surface of the food. As such, the surface dries out, becoming crispy and brown, while the inside stays moist.

In microwave cooking, the radio waves penetrate the food and excite water and fat molecules pretty much more evenly throughout the food. No heat conduction toward the interior occurs. There is heat everywhere all at once because the molecules are all excited together. However, there are drawbacks to microwave cooking. The radio waves penetrate unevenly in thick pieces of food and, as such, they don't make it all the way to the middle, and “hot spots” can be caused by wave interference.

Another method of cooking involves the use of a pressure cooker. These are pots for cooking food that are designed to maintain a pressure above atmospheric pressure. They consist of an enclosed pot that is placed on top of a stove file. Water in an open pot boils at 212 degrees F. at a standard atmosphere. No matter how long you continue to boil the water, it will stay at the same temperature. As the water evaporates and becomes steam it is also the same temperature, 212 degrees F. The only way to make the steam hotter (and/or to boil the water at a higher temperature) is to increase the pressure. This is what a pressure cooker does. The heat from the stovetop transfers through the metal pot to the contents (which generally include water and the items being cooked.) Since the pressure cooker is sealed, as the water inside the container expands to steam, the closed environment of the container causes the pressure inside the container to rise. The higher pressure, in turn, results in a higher temperature inside the vessel.

The laws of physics hold that, as long as pressure is uniform on all surfaces of an object, the object will not distort. In a pressure cooker, the pressure is effective throughout the food, from the surface through to the center. Thus, the increased pressure will not crush the food in the cooker.

At 15 psi, the temperature that water boils is about 250 degrees F., instead of 212 degrees F. The increased pressure inside the pot delays the water and/or other liquids inside the pot from boiling until the liquid reaches a much higher temperature. As a result, the cooking process is sped up considerably.

Air is a poor conductor of heat; but water is a good conductor. Steam, due to its water content, has approximately six times the heat potential than dry air when it condenses on a cooler food product. This increased heat transfer potential makes steam a much more effective cooking medium. Steam is efficient in transferring cooking heat rapidly to foods upon contact without burning or damaging the final product, and for less energy.

Generally, pressure cookers generate pressures from 5 to 15 psi. The main drawback to a pressure cooker is that the temperature inside the pressure cooker is limited to the boiling point of the water (i.e., 250 degrees F. at 15 psi). As such, the speed of cooking is also limited to this temperature. Table 1 lists the temperatures inside a pressure for various pressures.

TABLE 1

| | Pressure Inside |
|---|---|
| Cooking Temperature | The Pressure Cooker |
| 212° F. (100° C.) | 0 psi |
| 220° F. (104° C.) | 5 psi |
| 235° F. (113° C.) | 10 psi |
| 250° F. (121° C.) | 15 psi |

As meat cooks, the muscle fibers shorten in both length and width. As a result, the juices in the meat are eventually squeezed out. Thus, the longer a food cooks the drier it becomes.

For cooking purposes, meat consists of lean tissue, proteins, collagen and 75% water. Collagen exists in flesh, bone and connective tissue, and is very important to the cook because the amount of collagen in a piece of meat will determine the length of time it should be cooked. Therefore, the higher the level of connective tissue, the longer the meat will need to be cooked. Weight-bearing muscles and muscles that are constantly used contain higher amounts of collagen than muscles that aren't used for support or aren't used as frequently.

A number of different things happen as a food cooks, especially meats and poultry. At about 104 degrees F., the proteins in meat start to denature. At about 122 degrees F., the collagen begins to contract. At about 131 degrees F., the collagen starts to soften. At about 160 degrees F., the meat no longer holds oxygen and turns gray. Finally, at about 212 degrees F., the water in the meat begins to evaporate into steam, drying out the meat.

A turkey is considered cooked when the temperature inside the thickest part of the turkey is approximately 185 degrees F. Table 2 lists the approximate cooking times for a turkey at 325 degrees F.

TABLE 2
Cooking times for a turkey at 325 degrees F.

| Weight | Unstuffed | | Stuffed | |
|---|---|---|---|---|
| 8 to 10 pounds | 2¾-3 | hours | 3-3½ | hours |
| 12 to 14 pounds | 3-3¾ | hours | 3½-4 | hours |
| 14 to 18 pounds | 3¾-4¼ | hours | 4-4¼ | hours |
| 18 to 20 pounds | 4¼-4½ | hours | 4¼-4¾ | hours |
| 20 to 24 pounds | 4½-5 | hours | 4¾- 5¼ | hours |

As is evident from Table 2, the time to cook a turkey is significant. To date, no method has been introduced to speed the process along. Pressurized cooking has not been a viable option given the small size of the pot and the limited cooking temperature.

A need exists for an improved oven for cooking food products.

### SUMMARY OF THE INVENTION

The present invention relates to a pressurized oven system that includes an oven enclosure having front, back, top, bottom and side walls. A door is hingedly attached to one of the walls for sealing an opening in the walls. A heating system is connected to the enclosure for generating heat in the enclosure. The heating system may be a gas or electric heating system configured to heat the interior of the oven enclosure.

A pressure source is connected to the enclosure for supplying a pressurized fluid into the enclosure in order to create an atmosphere inside the enclosure that is above atmospheric pressure.

The oven system also includes a control system with at least one pressure sensor and at least one temperature sensor for monitoring and controlling the temperature and pressure within the enclosure.

The pressure source may be an external gas supply for supplying pressurized air into the oven, preferably between about 0 and about 25 psi.

The oven system may also include a liquid conduit for channeling a liquid into the enclosure to increase the moisture content within the enclosure during cooking.

In one embodiment, the system includes an enclosure connected to the oven for generating a gaseous smoke for feeding into the oven enclosure.

A process is also disclosed for cooking a food item in an oven. The process involves generating heat within the oven; creating pressure within the oven enclosure above atmospheric pressure during at least a portion of the cooking process; maintaining the pressure within the oven enclosure during at least a portion of the heating process; and controlling the heating and pressure during the cooking process.

The process optionally involves creating a moist environment within the oven enclosure, such as by supplying a liquid into the enclosure. The process may also optionally include the step of creating an acidic environment within the oven enclosure, such as with the supply of a smoke and carbon dioxide.

The foregoing and other features of the invention and advantages of the present invention will become more apparent in light of the following detailed description of the preferred embodiments, as illustrated in the accompanying figures. As will be realized, the invention is capable of modifications in various respects, all without departing from the invention. Accordingly, the drawings and the description are to be regarded as illustrative in nature, and not as restrictive.

### BRIEF DESCRIPTION OF THE DRAWINGS

For the purpose of illustrating the invention, the drawings show forms of the invention which are presently preferred; it being understood, however, that the invention is not limited to the precise arrangement and instrumentality shown.

FIG. 1 is an isometric view taken from the rear of an oven assembly according to one embodiment of the invention.

FIG. 2 is an isometric view taken from the front of the oven assembly of FIG. 1.

FIG. 3 is a rear view of the oven assembly of FIG. 1.

FIG. 4 is a side view of the oven assembly of FIG. 1.

FIG. 5 is a front view of the oven assembly of FIG. 1.

FIG. 6 is a top view of the oven assembly of FIG. 1.

FIG. 7 is an isometric view taken from the front of an oven according to a second embodiment of the invention.

FIG. 8 is a front view of the oven of FIG. 7.

FIGS. 9A-9D illustrate another embodiment of a door for use in the present invention in various stages of closing.

FIGS. 10A-10D illustrate side views of the door of FIGS. 9A-9D in the various stages of closing.

### DETAILED DESCRIPTION OF THE PREFERRED EMBODIMENTS

Referring to the figures wherein like reference numerals illustrate similar components, two embodiments of the invention are shown that are presently preferred. It would be readily apparent to those skilled in the art that a variety of modifications are possible within the scope of the present invention. The present invention is directed toward an improved cooking apparatus and associated method or process for cooking food stuffs. More particularly, the present invention, in one configuration, is directed to a pressurized oven 10.

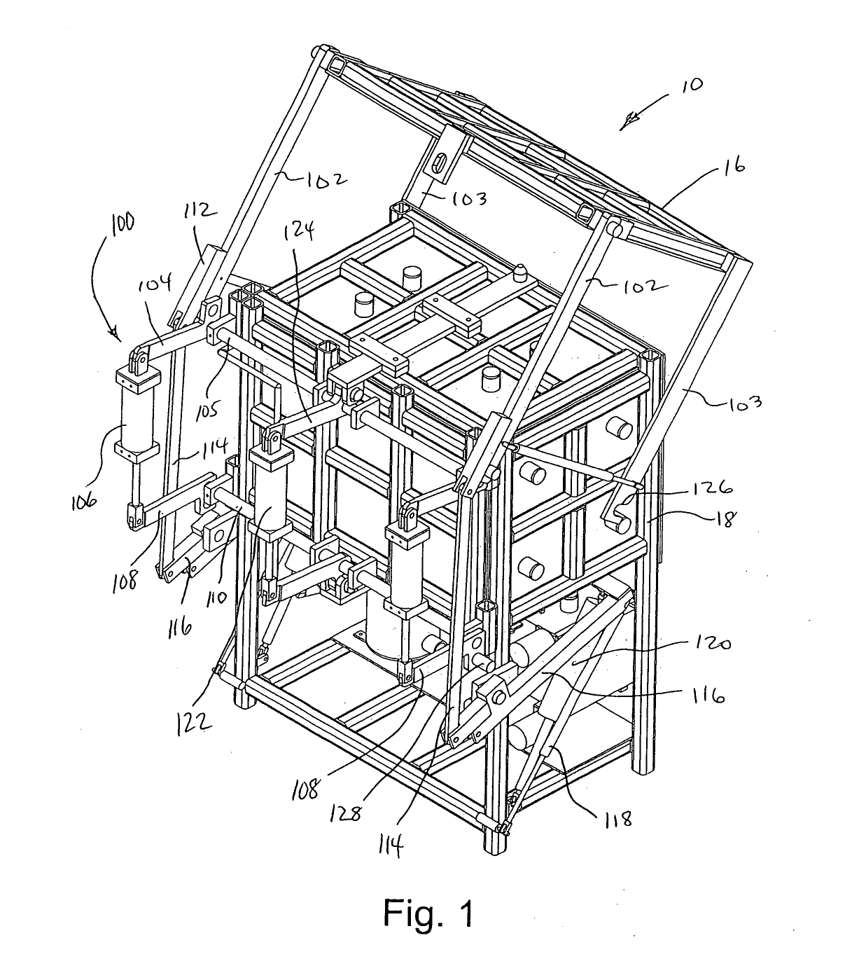

FIG. 1 illustrates an isometric view of one embodiment of the oven 10 according to invention. The oven 10 generally includes a multisided, preferably five sided, walled oven enclosure 12 with an opening 14. A door 16 is provided that is designed to close off the opening 14. As will be discussed in more detail below, the door 16 is designed to seal the opening so as to prevent or inhibit heat and gases from passing out of the opening 14 when the door 16 is open. It should be readily apparent that the enclosure may be made so as to have any convenient shape and preferably includes an outer cabinet (not shown for simplicity of discussion.)

The oven enclosure 12 is preferably made from conventional materials, such as steel, and configured to withstand pressures in excess of ambient. More preferably, the oven enclosure walls 12 are designed to withstand pressures greater than 5 psi and more preferably greater than 20 psi. The present invention contemplates that the oven will be subjected to internal pressures ranging between 0 psi and 20 psi during most cooking cycles, but the present invention is not limited to those pressures and, depending on the food it is designed to be used to cook, can be constructed so as to withstand pressures higher that 20 psi during use. The walls of the oven enclosure 12 are, thus, preferably designed to withstand the likely highest pressures that the particular oven is intended to be used for. Suitable walls may be constructed, for example, through the use of steel plates reinforced by an enclosure support frame.

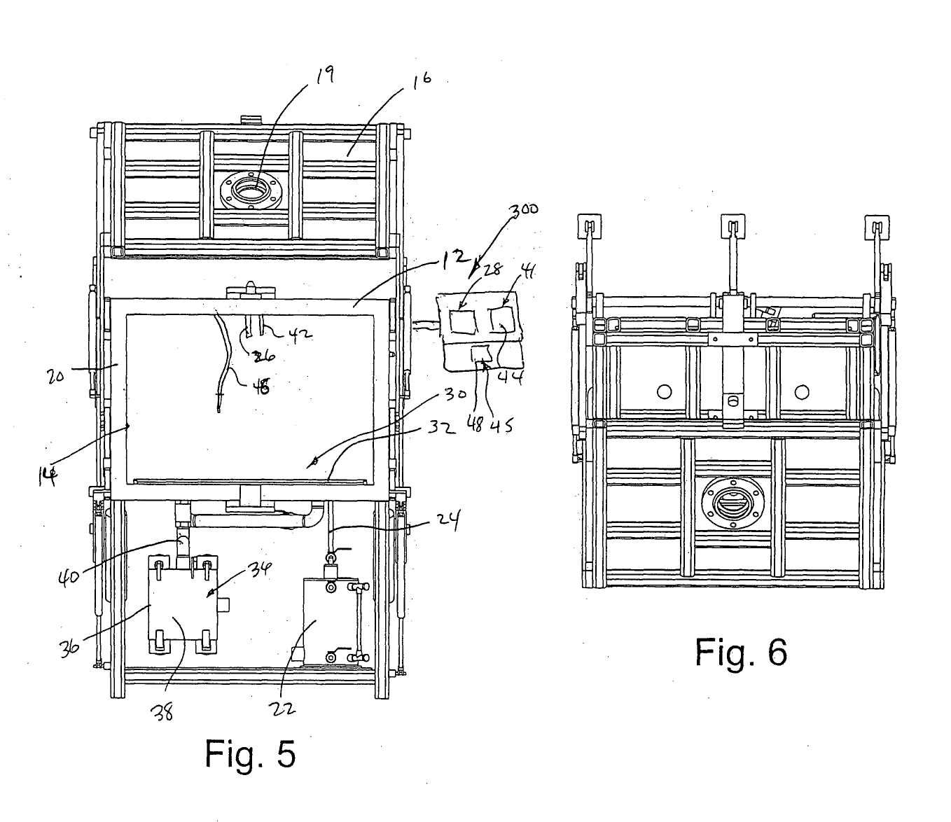

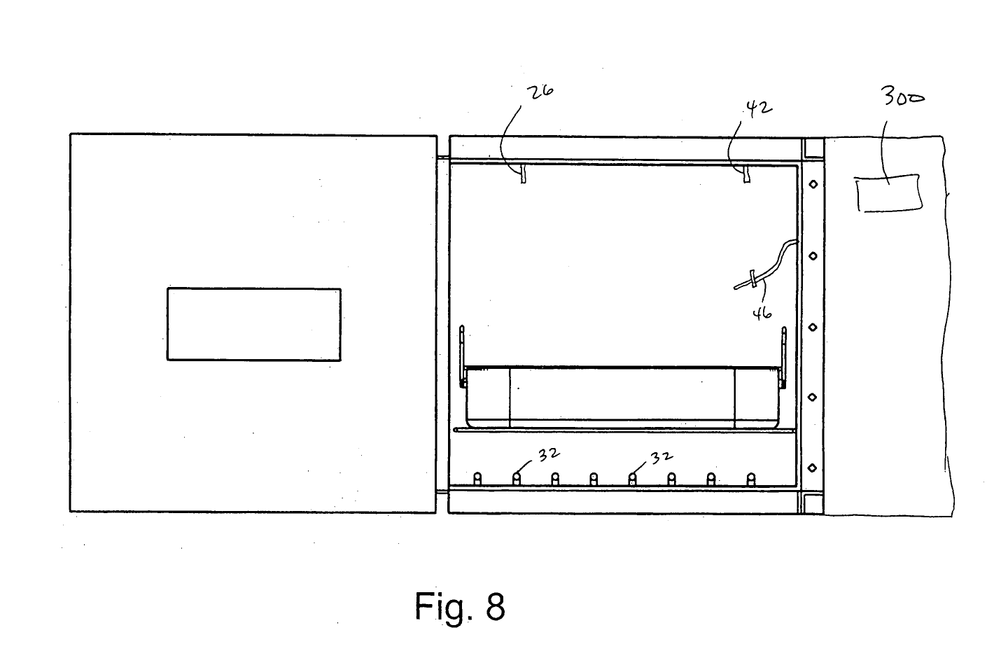

In one embodiment, the oven enclosure 12 is mounted to a frame 18 designed to support the oven enclosure 12. In the illustrated embodiment of FIG. 1, the frame 18 maintains the oven enclosure 12 at a suitable height off the floor so as to position the opening 14 at an appropriate height for use. As will be discussed in more detail below, various pieces of equipment may be located beneath the enclosure or, if desired, placed above or behind the enclosure 12. Although the embodiment of FIGS. 1-6 position the oven off the floor, it is also contemplated that that oven enclosure 12 may be mountable to a pre-existing frame, such as in a wall of a home, or may be configured to sit on a countertop.

A seal 20 is located between the door 16 and the edge of the enclosure 12 that surrounds the opening 14. The seal 20 is preferably designed to be substantially air tight so as to prevent or minimize pressure loss from the oven when the door 16 is closed and the oven is operational. In addition, the seal 20 should tolerate the anticipated temperatures. The seal 20 may be mounted to the door 18 or the enclosure 12. The seal may be pressurized to a higher pressure than the pressures anticipated inside the oven.

The door 16 may include a window 19, such as tempered glass, so as to permit the user to view the food item during the cooking process. A light (not shown) may also be mounted so as to provide illumination of the food item during cooking.

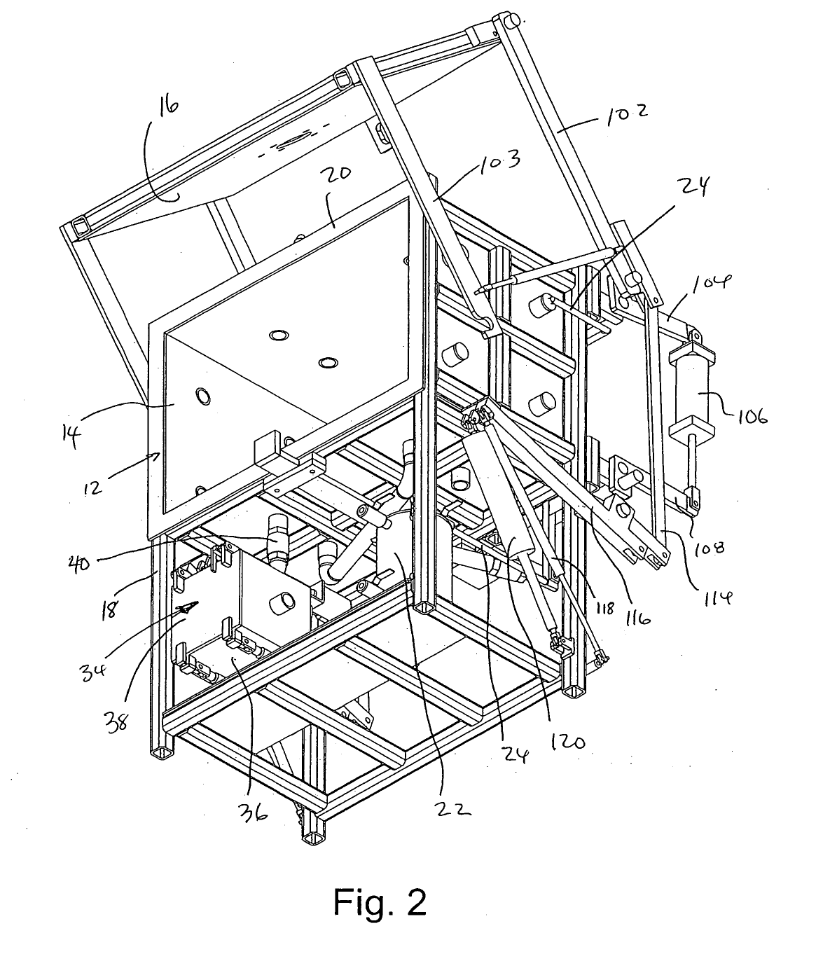

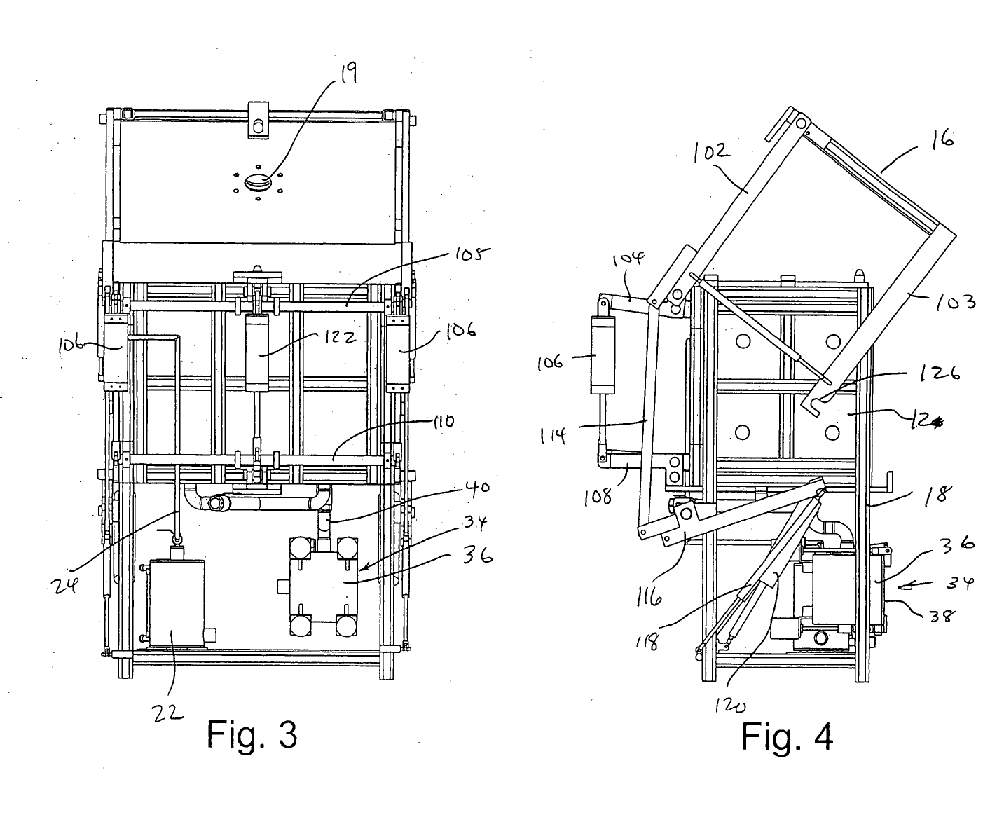

A pressure source 22 is connected to the oven enclosure 12. Preferably the pressure source 22 is mounted to the frame 18, although it is also anticipated that the pressure source can be external from the oven 10 and connected through suitable conduits. In one exemplary embodiment, the pressure source 22 is a high pressure air or gas compressor capable of supplying pressurized air between 0 and 25 psi. One or more gas supply conduits 24 connect the pressure source 22 to the oven enclosure 12. In the illustrated embodiment of FIGS. 2 and 3, the gas supply conduit 24 connects to the side of the enclosure 12 at a location near the top. This location permits the pressurized air to flow into oven enclosure 12 and circulate around the enclosure. Other mounting locations are also envisioned. For example, the gas supply conduit 24 could be mounted to the bottom or top and a deflector or baffle could be positioned adjacent to the conduit end so as to deflect the incoming pressurized gas in a preferred or desirable direction. Generally, the design should refrain from channeling the gas directly toward the area where the food is placed. If more than one gas supply conduit is used, they may be located on opposite sides of the enclosure 12.

A pressure sensor 26 is mounted within the enclosure 12 and connected to a pressure gauge 28 mounted on the enclosure 12 or the frame 18. The pressure sensor 26 monitors the pressure within the enclosure 12 and provides a reading on the pressure gauge 28. The pressure gauge may be analog or digital.

The oven includes a heating system 30. Any conventional heating system, such a an electric or gas heater, may be used. In one embodiment, the heating system 30 is an electric heating system that includes one or more electric burners or heating coils or rods 32 mounted within the enclosure 12. Preferably the electric coils are positioned along the bottom with a suitable deflector or mesh screen (not shown). In an electric heating system, the oven would preferably include an electric supply (not shown) for connecting to an electric power source. A control system would control the flow of the electric power to the coil. In one embodiment of the invention, the oven includes eight 1000 Watt heating rods and two 1500 Watt heating rods. To efficiently control the heat generation in the oven, the bottom may be insulated, such as with a ceramic sheets, thermal insulation or fiber board.

In an alternative embodiment, the heating system can be a gas heating system that includes gas burners positioned along the bottom of the enclosure and a deflector for providing more efficient heat distribution, similar to conventional oven arrangements. A gas heating conduit would be used to supply natural gas from a natural gas source. An ignition system, such as a pilot light or electric igniter, would be incorporated for igniting the natural gas, as is common in the art.

In addition to, or as an alternate for, the gas or electric heating systems, the present invention may include a radiant heating system. Radiant heaters are generally known, and can be incorporated into the heating system so as to provide a mechanism for crisping the external surface of the food product being cooked.

A smoker assembly 34 may be incorporated into the system to provide optional flavor enhancement during cooking. In the illustrated embodiment, the smoker assembly 34 includes a smoke box 36 with an access door 38. The access door is preferably hinged to the box 36 so that the operator can easily open the door 38 to feed suitable smoking products, like mesquite wood. The smoker box includes a burner assembly (not shown), such as a heating coil (electric) or natural gas burner, similar to the oven above, to heat the chips or wood. The smoker assembly 34 is preferably similar to conventional smoker assemblies attached to gas grills except that the smoker is pressurized. That is, an external pressure source, preferably the same pressure source as the oven, pressurizes the smoker box. A smoker conduit 40 connects the smoker box 36 to the interior of the oven enclosure 12. A one way valve is preferably located on the conduit line and prevents backpressure into the smoker box from the oven. As long as the pressure within the smoker box is greater than the pressure in the oven, the smoke from the box will flow into the oven.

Other methods can be used for channeling the smoke into the oven, such as a venturi line connected to the gas supply conduits 24 allowing the pressurized gas flowing into the oven to draw the smoke from the smoke box into the over enclosure. It is also contemplated that the smoker box may be sealed such that the heating of the air within the smoker box will naturally cause the pressure within the box to increase. Once the pressure is above a threshold amount, such as greater than the pressure in the oven, the smoke will channel into the oven enclosure from the smoker box.

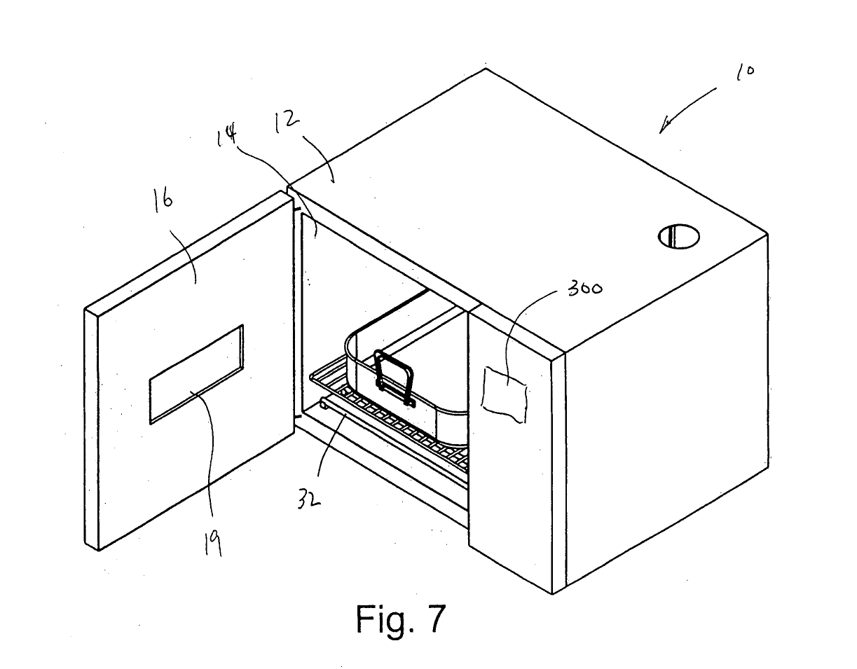

As shown in FIG. 5, the heating system 30 also includes an oven temperature monitor 41 to detect the temperature of the inside of the oven. The oven temperature monitor preferably includes an oven temperature sensor 42 positioned within the enclosure 12, and a display or gauge 44 preferably located outside the enclosure. The oven temperature monitor may be a conventional analog thermometer designed to operate within the anticipated temperature ranges and pressures. More preferably, the oven temperature monitor 41 is digital with a digital signal from the temperature sensor being displayed as a temperature value on the display 44. Oven temperature sensors, displays and monitors are well know in the art and, therefore, no further discussion is necessary.

The heating system 30 also preferably includes a food temperature monitor 45 to detect and monitor the temperature of the food. The food temperature monitor preferably includes a food temperature sensor 46 positioned within the enclosure 12 and which may be a conventional temperature probe designed to be inserted into the food product. A display or gauge 48 is preferably located outside the enclosure. The food temperature monitor may be a conventional analog thermometer designed to operate within the anticipated temperature ranges and pressures. More preferably, the food temperature monitor is preferably a digital device that receives a digital signal from the food temperature sensor and displays it as a temperature value on the display 48. Food temperature sensors, displays and monitors are well know in the art and, therefore, no further discussion is necessary.

An electronic controller 300 is used to control the supply of pressurized gas. The controller 300 is adapted to receive, for example, a variety of information, preferably including signals indicative of the pressure inside the enclosure from the pressure sensor 26, the temperature inside the enclosure from the oven temperature sensor 42, the temperature of the product being cooked from the food temperature sensor 46. The electronic controller 300 is preferably configured to control one or more features and/or components of the oven. For example, the controller 300 is preferably connected to the pressure source 22 and/or the gas supply conduit 24 for controlling supply of the pressurized gas to the enclosure 12. In such an embodiment, if the controller 300 senses that the pressure within the enclosure is below a desired value, the controller 300 controls a valve for supplying the pressurized gas along the gas supply conduit 24 until the pressure within the enclosure is above a desired level. Alternately, the controller could activate the pressure source 22 to begin to further pressurize the gas that is supplied.

If the oven includes a smoker assembly as discussed above, the controller 300 can be used to separately control the smoker.

The controller 300 could also activate an alarm if a prescribed time frame has completed (e.g., cooking cycle) or if a pressure exceeds a desired value.

The controller 300 may also include a memory for storing various prescribed cooking procedures, and a selection device, such as a touch screen, buttons, keyboard or other mechanism for allowing an operator to program, store, and/or select a cooking procedure. Other uses and configurations for the controller will be explained below. A variety of controllers exist that can be configured to provide the necessary functionality described herein, including controllers using hardware, software or firmware components. The selection device may be physically attached to the controller or may be a separate component such as a remote control unit. It is also contemplated that the controller could be connected to a wireless or wired network (either directly or through the internet) so that remote programming and monitoring of the controller, and hence the oven, is possible using a standard general purpose computer or a dedicated computer device. As such, as series of ovens in a cooking facility can be monitored and controlled through a single computer system.

A temperature limiter can be included to prevent over heating of the oven. The limiter can be fixed, such as a absolute maximum temperature, or could be adjustable, such as a maximum temperature for the particular food being cooked.

Although the controller 300 has been described as being separate from the gauges and controls for the heating system, it is also contemplated that features of the heating controls, such as the gauges, can be part of the controller 300, or that the heating controls, including the displays, and monitoring and control functionality can be provided through a software based system that operates through a display screen mounted to or separate from the oven.

In order to permit the temperature to increase within the oven, one or more vents (not shown) are formed in the oven, preferably in the top on either side for the oven, and adapted to channel gas (air) out of the oven. The location of the vents provides for some controlled flow inside the oven. It should be readily apparent that the venting and/or pressurizing of the oven should be designed and/or controlled so that, during cooking, the volume of gas (air) being channeled into the oven is preferably equal to or greater than the volume of gas (air) being vented so that the gas (air) pressure within the oven increases. The controller 300 can control the pressure into and out of the oven so as to provide for the proper pressurization of the oven.

Referring to FIG. 1, the door 16 may be attached to the oven enclosure 12 in any convention manner. One preferred door hinge assembly 100 is illustrated in the drawings for attaching the door 16 to the frame 18. In this embodiment, the door hinge assembly 100 is designed to pivot the door up and away from the opening of the enclosure. The door hinge assembly 100 includes two sets of upper and lower support arms 102, 103, each set being rigidly attached to the top and bottom of a side of the door 16. The opposite end of each upper support arm 102 is pivotally attached to one leg of an upper dogleg link 104. The upper dogleg link 104 is attached to an upper crossbar 105 at a point between its ends. The upper crossbar 105 preferably connects to both upper doglegs 104 and is support by a bracket on the frame 18 so as to permit the dogleg to pivot with respect to the frame 18.

The second end of each dogleg link 104 is attached to an upper end of a first piston assembly 106. The piston assembly 106 may be a hydraulic or pneumatic piston. The lower end of each piston assembly 106 is attached to a first end of a lower dogleg link 108. The lower dogleg link 108 is attached to lower crossbar 110 at a point between its ends. The lower crossbar 110 preferably connects to both of the lower doglegs 108 and is support by a bracket on the frame 18 so as to permit the lower doglegs 108 to pivot with respect to the frame 18.

A bracket 112 is fixedly attached to the end of the upper support arm 102 and pivotally attached to one end of a first control arm 114. The opposite end of the first control arm 114 is pivotally connected to a second control arm 116. The second control arm 116 is pivotally mounted to a bracket on the frame 18 between the ends of the second control arm 116. The second end of the second control arm 116 is pinned to preferably two struts or dampers 118, 120 which, in turn, are pinned to brackets on the bottom of the frame. These struts control the pivotal motion of the second control arm 116 about its pivotal mount to the frame 18.

The combination of the upper support arm 102, the upper dogleg 104, the piston assembly 106 and the lower dogleg 108 control the motion of the top of the door 16 toward and away from the enclosure. More particularly, in light of the increased pressure and temperature that is created in to over, the door attachment assembly is designed to move the top of the door 16 away from the enclosure about ½ to 1 inch in order to vent the heat and gas from the oven prior to the door opening completely.

The combination of the upper support arm 102, the first control arm 144, the second control arm 116 and the struts 118, 120 control the lifting and rotation of the door 16. Thus, after the top of the door 16 has shifted away from the enclosure to vent the oven, this second combination of elements rotates the door away from the enclosure into the position shown in the figures.

A control piston 122 is connected to the upper control arm 105 through a center dogleg link 124 and designed to rotate the upper control arm 105. Rotation of the upper control arm controls the rotation of the upper doglegs 104 which, in turn, control the swiveling of the door between the open and closed positions.

The piston 106, 122 are connected to a switch which controls the operation of the pistons and, thus, the opening and closing of the door 16. The switch is preferably part of the controller 300.

The lower support arms 103 preferably include a notch 126 designed to engage with a pin 128 extending out from the frame so as to secure the lower support arms to the frame when the door is closed.

While one preferred embodiment of the door hinge assembly is shown in the drawings, it would be readily apparent to those skilled in the art to provide alternate door hinge assemblies, in light of the discussion above. For example, the door can be attached to the frame through a simple hinge and a lock provided that secures the door to the frame so as to prevent the internal pressure from forcing the door open.

The increased pressure and higher temperature in the oven creates a denser atmosphere in the enclosure. The denser atmosphere allows for radiated energy from the heating source to reach the surface of the food quicker. The denser air acts like a solid material, resulting in a form of conduction through the gas. Preferably water is added to the gas or channeled into the oven so as to result in a steam being generated within the enclosure. This moist atmosphere produces a moisturizing of the food being cooked, thus preventing the food from drying out during cooking. A separate water supply may be attached to the oven and a conduit provided to supply the water into the oven in the form of a mist (such as with a diffuser) or injected into the gas stream flowing into the oven. Alternately, the natural water content of the food will assist in creating the steam environment.

The applicant has determined that the skin of poultry is semi-permeable. Hence, the browning of the skin on poultry would tend to prevents permeation of moisture into the food. However, in the present oven, the increased pressure forces the moisture through the skin into the meat product, thus increasing the moisture content of poultry over conventional ovens.

The addition of the smoke to the cooking process makes the air inside the oven more acidic. That is, the smoke changes the water molecules in the air to an acid which provides a unique and beneficial cooking environment. For example, the pressurized gas and liquid systems discussed above can be used to create a gaseous (gas-liquid) cooking marinade that is directed into the oven. In one embodiment, CO₂ can be added to water (or added to a moist environment within the oven enclosure) and combined with smoke from the smoker to create a carbonic acid within the enclosure. The carbonic acid will penetrate into the meat and tenderize the meat. The acid tends to breakdown tendons and other tough features of meat and poultry. The pressure assists in forcing the additional gas element into the water.

The increased pressure of the gas within the oven allows for additional moisture to be added since the saturation level of the gas is generally higher at a higher temperature and pressure than at a lower pressure and temperature. As such, the oven permits more moisture than a conventional oven. Also, generally at higher temperature, air alone will have a lower density. So the addition of pressure into the oven raises the density of the air above where it would be in a conventional oven. For example, Table 3 shows the effect that temperature and pressure have on air.

TABLE 3
Density of Air (lb/ft³) at Different Temperatures

| Air Temp. | Gauge Pressure (psi) | | | | |
|---|---|---|---|---|---|
| (° F.) | 0 | 5 | 10 | 20 | 30 |
| 30 | 0.081 | 0.109 | 0.136 | 0.192 | 0.247 |
| 40 | 0.080 | 0.107 | 0.134 | 0.188 | 0.242 |
| 50 | 0.078 | 0.105 | 0.131 | 0.185 | 0.238 |
| 60 | 0.076 | 0.102 | 0.128 | 0.180 | 0.232 |
| 70 | 0.075 | 0.101 | 0.126 | 0.177 | 0.228 |
| 80 | 0.074 | 0.099 | 0.124 | 0.174 | 0.224 |
| 90 | 0.072 | 0.097 | 0.121 | 0.171 | 0.220 |
| 100 | 0.071 | 0.095 | 0.119 | 0.168 | 0.216 |
| 120 | 0.069 | 0.092 | 0.115 | 0.162 | 0.208 |
| 140 | 0.066 | 0.089 | 0.111 | 0.156 | 0.201 |
| 150 | 0.065 | 0.087 | 0.109 | 0.154 | 0.198 |
| 200 | 0.060 | 0.081 | 0.101 | 0.142 | 0.183 |
| 250 | 0.056 | 0.075 | 0.094 | 0.132 | 0.170 |
| 300 | 0.052 | 0.070 | 0.088 | 0.123 | 0.159 |
| 400 | 0.046 | 0.062 | 0.078 | 0.109 | 0.141 |
| 500 | 0.041 | 0.056 | 0.070 | 0.098 | 0.126 |
| 600 | 0.038 | 0.050 | 0.063 | 0.089 | 0.114 |

One test was conducted using the oven described above. In the test, the oven was operated at 425 degrees and pressurized from 16-17.5 psi. The result was that a 16 pound turkey cooked completely in 50 minutes and remained very moist. This compares with a conventional oven which takes approximately 3½ A hours to cook the same size turkey.

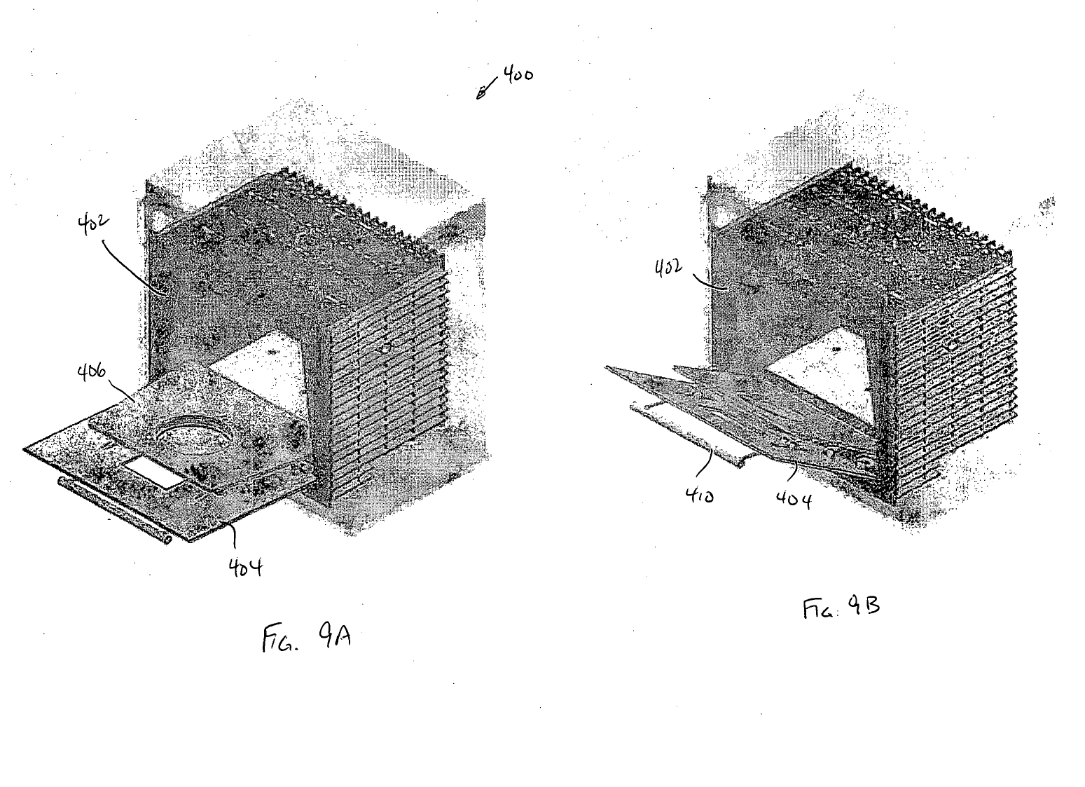

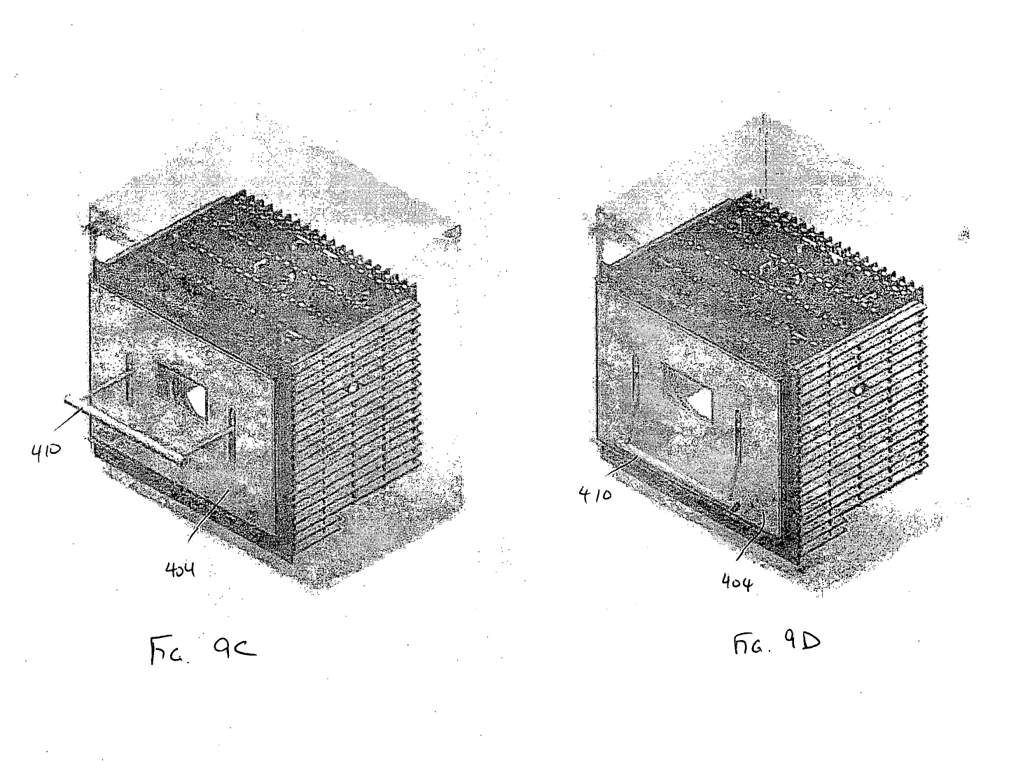

The oven illustrated in FIGS. 1-6 is configured as a large commercial oven. A smaller version has been designed for residential use. FIGS. 7 and 8 illustrate such as design. The components described above of the oven would preferably be mounted on the side and back of the oven enclosure within the cabinet. This design provides a more compact version of the oven. Most of the components described above with respect to the first embodiment of the invention would be included in the embodiment shown in FIGS. 7 and 8, and are depicted with the same reference numerals.

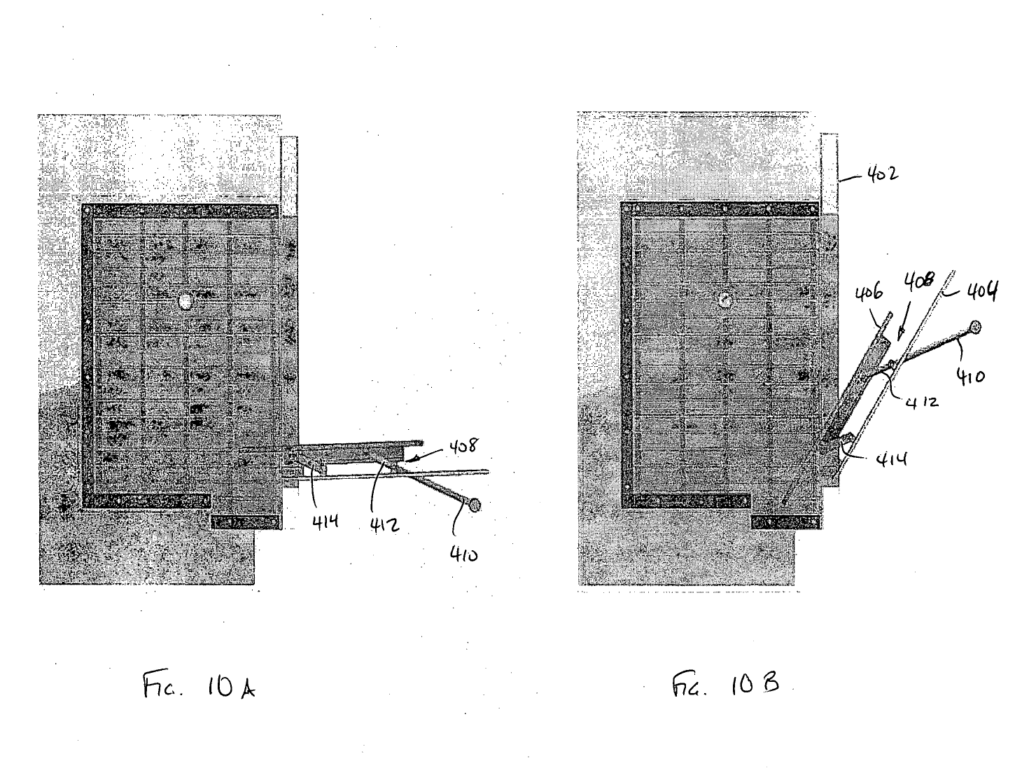

Referring to FIGS. 9A-9D illustrate an alternate embodiment of a door 400 for use in the pressurized oven system. Since the pressure in the oven tends to push the oven door outward, typical doors that pressure inward to seal are constantly fighting the pressure inside the oven. In an alternate concept, a unique door is disclosed that uses an inner door wall that, when the door is in its closed position, is located inside the door frame on the front wall such that pressure inside the oven forces the inner door wall against the door frame, providing a strong seal.

As shown in FIG. 9A, in this embodiment, the door frame or opening 402 is not square or rectangular. Instead, it has a trapezoidal shape, with the top 402T of the frame having a width that is less than the bottom 402B of the frame and the sides 402S tapering inward as shown. The door 400 includes an outer wall 404 and an inner wall 406. The outer wall can have a conventional appearance, and is hinged to the oven near the bottom 402B of the door frame. The inner wall 406 has a trapezoidal shape that is the same as the door frame only slightly larger. The inner wall 406 is mounted to the outer wall 404 through a linkage or articulation mechanism 408 that permits the inner wall to move parallel to the outer wall. The linkage 408 includes a handle 410 that passes through the outer wall to the inner wall.

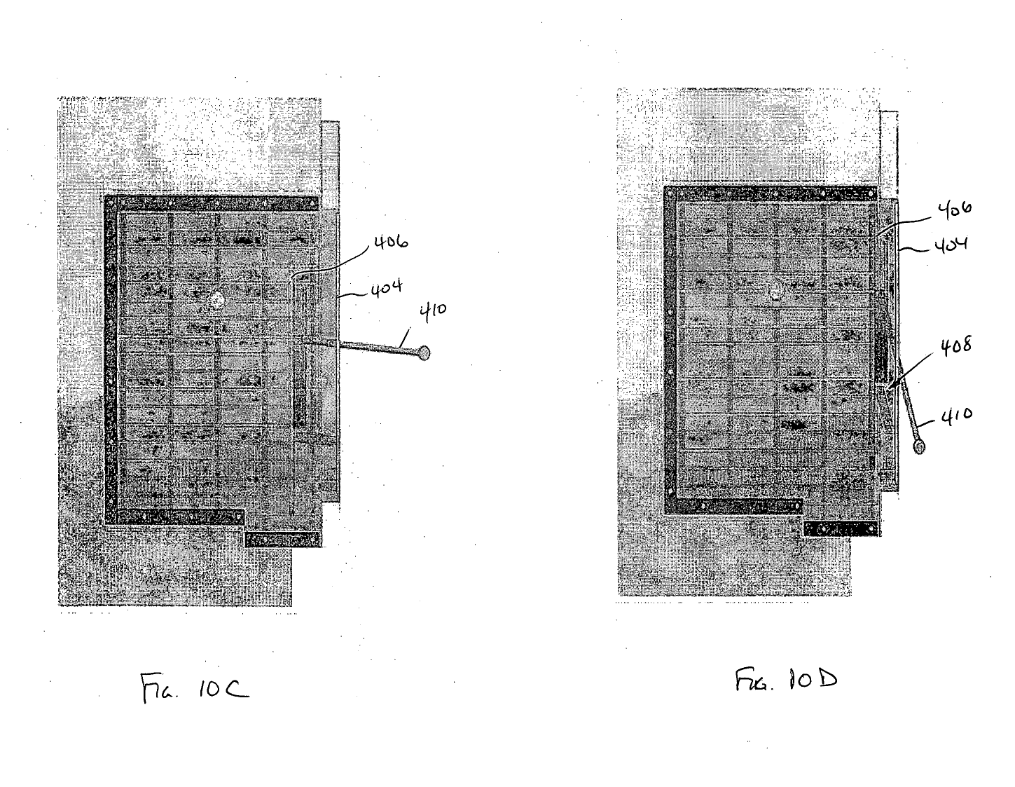

As FIGS. 9A-9D, and 10A-10D illustrate, the inner door is mounted to the outer door such that when the outer door is placed against the oven, the inner door is positioned slightly downward from the door frame 402. This permits the inner wall to pass through the door frame opening. Once the outer door 404 is against the front door frame 402 as shown in FIGS. 9C and 10C, the handle 410 is pivoted from an unlocked position (shown in FIGS. 9C and 10C as extending outward) to a locked position shown in FIGS. 9D and 10D.

More particularly, the linkage mechanism includes, in one embodiment, two upper links 412 and two lower links 414 near the sides of the inner door 406. Each link is attached at each end to the inner door and outer door through a pivot connection (such as a pinned connection). Thus, the linkages and the inner and outer doors form, in essence a four bar linkage system for controlling movement of the inner door relative to the outer door. As the outer door 406 is transitioned from the open position (FIGS. 9A and 10A) through the closed, but unlocked position (FIGS. 9C and 10C), the linkage mechanism 408 maintains the inner door in its unlocked position. As the handle 410 is engaged (pulled downward in FIGS. 9D and 10D), the linkage causes the inner door to slide upward and slightly outward against the inside surface of the door frame, thus placing the door in its locked position.

Those skilled in the art will recognize in light of the above discussion that there are other ways to form the door and locking mechanism and, thus, the present invention is not limited to the particular configuration disclosed.

As discussed above, moisture created inside the oven can be used to enhance the cooking of the food. For example, spices and other flavor enhancers, can be placed on the item to be cooked in a dry state. During the heating process, the moisture in the oven enclosure can be controlled to cause the spices to form a marinate as the drain off into the cooking pan. The controller can be used to monitor the moisture content within the oven and in the food product using a humidistat or other conventional sensor.

Variations, modifications and other implementations of what is described herein will occur to those of ordinary skill in the art without departing from the spirit and scope of the invention. Accordingly, the invention is in no way limited by the preceding illustrative description.

1. An oven system for creating a pressurized cooking environment comprising:
an oven enclosure having back, top, bottom and side walls, the side, top and bottom walls having front ends defining a front opening into the enclosure, a door hingedly attached to one of the ends of the walls for sealing the front opening in the enclosure;
a heating system connected to the enclosure for generating heat in the enclosure;
a pressure source connected to the enclosure for supplying a pressurized fluid into the enclosure so as to create an atmosphere inside the enclosure that is above atmospheric pressure;
a locking mechanism attached to enclosure and configured to lock the door to the enclosure so as to prevent the door from rotating about its hinge and restrict access to the interior from the front opening, the locking mechanism including a locked state where the locking mechanism is engaged with the door so as to maintain the door against the front opening and prevent rotation of the door about its hinge, and an unlocked state where the locking mechanism permits the door to rotate about its hinged attachment so as to permit access into the oven enclosure through the front opening;
a venting system connected to the enclosure and in communication therewith, the venting system providing controlled venting of air from inside the enclosure; and
a control system including at least one pressure sensor and at least one temperature sensor for monitoring and controlling the temperature and pressure within the enclosure, the control system connected to the locking mechanism and the venting system, the control system inhibiting opening of the door until the control system determines the pressure within the enclosure is below a threshold level, the control system controlling the pressure in the enclosure by venting air from within the enclosure through at least the venting system.

2. The oven of claim 1, wherein the pressure source is external to the enclosure, and wherein at least one gas supply conduit channels the pressurized fluid into the enclosure during cooking.

3. The oven according to claim 1, wherein the pressure source is a high pressure air or gas compressor capable of supplying pressurized air between about 0 and about 25 psi.

4. The oven according to claims 2, wherein the gas supply conduit connects to at least one of the enclosure walls near the top so as to permit the pressurized air to flow into oven enclosure and circulate around the enclosure.

5. The oven according to claim 2, wherein the oven includes a gas valve attached to the gas conduit and a switch attached to the heating system, and wherein the controller controls the valve and the switch for controlling the pressure and temperature inside the enclosure.

6. The oven according to claim 1, wherein the heating system is a gas heater or an electric heater.

7. The oven according to claim 1, further comprising a liquid conduit for channeling a liquid into the enclosure to increase the moisture content within the enclosure during cooking.

8. The oven according to claim 7, wherein the liquid conduit connects with the pressure source so as to feed a supply of liquid into the pressurized air stream that enters the oven from the pressure source.

9. The oven according to claim 1, further comprising an enclosure for generating a gaseous smoke, the enclosure being connected to the oven enclosure for channeling the generated smoke into the oven enclosure.

10. A process for cooking a food item in an oven comprising the steps of:
providing an oven system with an oven enclosure according to claim 1;
placing a food item into the oven enclosure;
maintaining the door in a locked state during a cooking process and while the pressure within the oven enclosure is above the threshold value with the controller;
generating heat within the interior of the oven enclosure;
causing pressure within the interior of the oven enclosure above atmospheric pressure during at least a portion of the cooking process;
monitoring the pressure within the oven enclosure during a cooking process with the controller so as to maintaining the pressure above atmospheric pressure within the oven enclosure during at least a portion of the heating process;
controlling the heat and pressure during the cooking process with the controller; and
venting the pressure from the oven enclosure with the controller so that pressure within the oven is below a threshold value prior to unlocking the door.

11. A process according to claim 10, further comprising the step of creating a moist environment within the oven enclosure.

12. A process according to claim 10, further comprising the step of creating an acidic environment within the oven enclosure.

13. A process according to claim 10, wherein the step of creating pressure within the oven enclosure involves supplying a gas to the enclosure.

14. (canceled)

15. A process for controlling an oven for cooking a food item comprising the steps of:
providing an oven comprising:
an oven enclosure with defined by a plurality of walls defining an interior, the enclosure having a front opening permitting access to the into the enclosure, a door hingedly attached to the enclosure for sealing the front opening in the enclosure and thereby controlling access to the interior,
a heating system connected to the enclosure for generating heat within the enclosure,
a locking mechanism attached to the enclosure and configured to lock the door to the enclosure so as to prevent the door from rotating about its hinge and restrict access to the interior from the front opening, the locking mechanism including a motorized actuator for transitioning the door from a locked state where the locking mechanism is engaged with the door so as to maintain the door against the front opening and inhibit rotation of the door about its hinge, and an unlocked state where the locking mechanism permits the door to rotate about its hinged attachment so as to permit access into the oven enclosure through the front opening;
a venting system connected to the enclosure and in communication therewith, the venting system including a motorized valve and a conduit communicating between the interior of the enclosure and the exterior of the oven, the valve providing controlled venting of air from the interior of the enclosure through the conduit, and
an electronic control system including at least one pressure sensor and at least one temperature sensor for monitoring and controlling the temperature and pressure within the interior of the enclosure, the control system electrically connected to the motorized actuator of the locking mechanism and electrically connected to the valve of the venting system, the control system inhibiting opening of the door until the control system determines the pressure within the enclosure is below a threshold level, the control system controlling the pressure in the enclosure by venting air from within the oven enclosure through at least the valve of the venting system;
placing a food item into the oven enclosure;
maintaining the door in its locked state during a cooking process and while the pressure within the oven enclosure is above the threshold value with the controller;
generating heat within the interior of the oven enclosure;
causing pressure within the oven enclosure to increase above atmospheric pressure during at least a portion of the cooking process;
monitoring the pressure within the oven enclosure during the cooking process with the controller so as to maintain the pressure above atmospheric pressure within the oven enclosure during at least a portion of the cooking process;
controlling the heat and pressure during the cooking process with the controller; and
opening the valve of the venting system with the controller to vent pressure from the interior of the oven enclosure and actuating the motorized actuator to unlock the door only when the pressure within the oven interior is below a threshold level.

16. An oven system comprising:
an oven enclosure having back, top, bottom and side walls, the top, bottom and side walls having front ends defining a front opening into an interior of the enclosure, a door hingedly attached to one of the ends of the walls for sealing the front opening in the enclosure;
a heating system connected to the enclosure to generate heat in the interior of the enclosure during use;
a locking mechanism attached to enclosure and configured to lock the door to the enclosure so as to prevent the door from rotating about its hinge and restrict access to the interior from the front opening, the locking mechanism including a motorized actuator for transitioning the door from a locked state where the locking mechanism is engaged with the door so as to maintain the door against the front opening and prevent rotation of the door about its hinge, and an unlocked state where the locking mechanism permits the door to rotate about its hinged attachment so as to permit access into the oven enclosure through the front opening;
a venting system connected to the enclosure and in communication therewith, the venting system including a motorized valve and a conduit communicating between the interior of the enclosure and the exterior of the oven, the valve providing controlled venting of air from the interior of the enclosure through the conduit; and
an electronic control system including at least one pressure sensor and at least one temperature sensor for monitoring and controlling the temperature and pressure within the interior of the enclosure, the control system electrically connected to the motorized actuator of the locking mechanism and electrically connected to the valve of the venting system, the control system controlling the pressure within the interior of the enclosure by maintaining the locking mechanism in its locked state and inhibiting venting of air through the valve of the venting system to allow the pressure within the interior of the enclosure to rise above ambient pressure, the control system controlling access to the interior of the oven by opening the valve of the venting system to vent air from the interior of the oven enclosure through the conduit and inhibiting actuation of the actuator to maintain the door in its locked state so as to prevent opening of the door until the control system senses the pressure within the interior of the enclosure is below a threshold level after which the control system actuates the actuator to unlock the locking mechanism and permit the door to be opened.

17. The oven system of claim 16 wherein the oven includes an atmosphere enhancement system for altering the composition of the gas within the interior in order to produce a gaseous atmosphere within the interior of the enclosure during a cooking process that enhances the cooking of the food product.

18. The oven system of claim 17 wherein the atmosphere enhancement system includes a supply conduit for channeling a substance into the interior to cause the gas within the interior to become acidic.

19. The oven system of claim 17 wherein the atmospheric enhancement system includes a chamber in the oven and connected to the interior of the enclosure through a supply conduit for channeling a gaseous substance into the interior to of the enclosure, the chamber including an access door for permitting access to the interior of the chamber by a user, the atmospheric enhancement system including a mechanism for pressurizing the chamber when the access door is closed for facilitating channeling of a gaseous substance from the chamber through the conduit and into the interior of the enclosure when the enclosure is pressurized.

20. The oven system of claim 16 wherein the actuator of the locking mechanism is located proximate to the back of the oven and includes linkages that engage with at least the top and bottom of the door for pulling the door toward the front of the door and the rear of the oven while the door mechanism is in its locked state.

21. The oven system of claim 16 further comprising a pressure supply system connected to the enclosure and including a conduit for channeling pressurized gas to the interior of the oven during a cooking process.
